(19) United States
(12) Patent Application Publication
(10) Pub. No.: US 2021/0065201 A1
(43) Pub. Date: Mar. 4, 2021

(54) System and Method for Enhanced Contact Transitioning

(71) Applicant: Introhive Services Inc., Fredericton (CA)

(72) Inventors: David HUDSON, Fredericton (CA); David GOYETTE, Fredericton (CA)

(21) Appl. No.: 17/006,318

(22) Filed: Aug. 28, 2020

Related U.S. Application Data
(60) Provisional application No. 62/893,547, filed on Aug. 29, 2019.

(51) Int. Cl. G06Q 30/00; G06Q 50/00; G06Q 10/10; G06F 16/28; G06F 16/21

(52) U.S. Cl. CPC G06Q 30/01; G06Q 50/01; G06Q 10/107; G06F 16/284; G06F 16/21; G06Q 10/1093

(57) ABSTRACT

Method and system for use in maintaining a relationship database, including receiving information identifying a departing user; retrieving, from the relationship database, relationship data for a plurality of individual contacts identified in the relationship database as having an existing relationship with the departing user; retrieving, from the relationship database, relationship data for other users identified in the relationship database as having existing relationships with the individual contacts; and generating a report identifying the individual contacts and the other users that have existing relationships with the individual contacts, the report including relationship information based on the retrieved relationship data about the existing relationship of the departing user with the individual contacts and the existing relationships of the other users with the individual contacts.

### CROSS-REFERENCE TO RELATED APPLICATION

This application claims the benefit of and priority to the following application, the contents of which are incorporated herein by reference: U.S. Provisional Patent Application No. 62/893,547 entitled “System and Method for Enhanced Contact Transitioning”, filed Aug. 29, 2019.

### TECHNICAL FIELD

The present disclosure invention relates to systems and methods for resource transition planning and Customer Relationship Management (CRM) systems.

### BACKGROUND

Enterprises such as companies, accounting firms, law firms, universities, partnerships, agencies and governments commonly use CRM systems and related technology to manage relationships and interactions with other parties such as customers and potential customers with clients.

One of the intangible values that an enterprise has today is the relationships that its employees build. Often relationships are stronger on a person-to-person basis versus a company-to-company basis.

One of the problems is that if an employee leaves the enterprise, it is often hard to identify the impact to the enterprise's relationships. It can often be determined what clients and accounts a departing employee worked with, but can be very difficult, and in some cases impossible, to identify who all of their individual contacts/relationships are and the value of those relationships.

Another problem is that sometimes contacts get ‘orphaned’ as in there is no other employee at the company with an existing relationship to a particular contact. This may lead to the loss of a contact if the orphaned contact is not identified and transitioned.

Another problem is that sometimes an employee's departure will cause a contact relationship to degrade. There may be another employee with a relationship with a contact, but it may be a minor relationship and not adequately cover the loss of the very strong relationship that the departing employee has with the contact.

There are additional considerations in regions that have data protection and privacy regulations enacted as law. Examples of these regulations would be, but not limited to, General Data Protection Regulation (GDPR), California Consumer Privacy Act (CCPA), and Personal Information Protection and Electronic Documents Act (PIPEDA). Some of these regulations place limitations on initiating contact with individuals in the absence of an existing relationship. These regulations may limit the ability for an enterprise to ‘re-connect’ with a contact after an employee departs.

There are solutions available today that will provide a list of contacts that the departing employee has based on, for example, their mobile contact list or email contact list. However, such solutions provide little or no information about the context or strength of a relationship and do not address the problems noted.

The foregoing examples of the related art and limitations thereto are intended to be illustrative and not exclusive. Other limitations of the related art will become apparent to those of skill in the art upon a reading of the specification and a study of the drawing.

### SUMMARY

According to a first example aspect is a computer implemented method for use in maintaining a relationship database. The method includes receiving information identifying a departing user; retrieving, from the relationship database, relationship data for a plurality of individual contacts identified in the relationship database as having an existing relationship with the departing user; retrieving, from the relationship database, relationship data for other users identified in the relationship database as having existing relationships with the individual contacts; and generating a report identifying the individual contacts and the other users that have existing relationships with the individual contacts, the report including relationship information based on the retrieved relationship data about the existing relationship of the departing user with the individual contacts and the existing relationships of the other users with the individual contacts.

In at least some embodiments, the retrieved relationship data includes a user-contact relationship score for each of the existing relationships, the user-contact relationship score indicating a perceived value of the existing relationship, and the relationship information included in the report includes the user-contact relationship scores.

In at least some examples, the method includes determining, based on the user-contact relationship scores, substitute users for transitioning at least some of the existing relationships of the departing user, and indicating the substitute users and respective individual contacts in the report.

In at least some examples, the method includes notifying one or more parties through electronic messaging of the substitute users.

In at least some examples, the method includes notifying the relationship database of the substitute users.

In at least some examples, the retrieved relationship data identifies scheduled future activities between the departing user and the individual contacts, and the method comprises automatically advising the respective substitute users of the scheduled future activities.

In at least some examples, the method includes presenting the report through a user interface to a data steward and receiving input through the user interface confirming the determined substitute users.

In at least some examples, the retrieved relationship data includes an indication of a last interaction for each of the existing relationships, and the relationship information included in the report includes the indications of last interaction.

In at least some examples, the retrieved relationship data includes, for each individual contact an overall individual relationship score that is based on a total of the user-contact relationship scores for the individual contact with the departing user and all other users identified as having an existing relationship with the individual contact, and the report includes an indication of a relationship of the user-contact relationship score for the individual contact with the departing user relative to the overall individual relationship score.

In at least some examples, the user-contact relationship scores are based on historical communication activities the departing user and the other users have each had with the individual contacts, wherein the method comprises automatically tracking the historical communication activities by monitoring electronic communication activities involving the departing user and the other users and providing information about the electronic communication activities to the relationship database.

According to a further example aspect is a computer system comprising a processor and persistent storage storing computer instructions that when executed by the processor configure the computer system to perform the method of one or more of the above aspects and examples.

According to a further example aspect is a computer readable medium storing, in a persistent manner, computer software instructions that when executed by a processor configure the processor to perform the method of one or more of the above aspects and examples.

### BRIEF DESCRIPTION OF DRAWINGS

Exemplary embodiments are illustrated in the referenced figures of the drawings. It is intended that the embodiments and figures disclosed herein are to be considered illustrative rather than restrictive.

FIG. 1 is a simplified block diagram illustrating an environment that includes an enterprise network and a CRM support system in accordance with an example embodiment of the present disclosure.

FIG. 2 is a flow diagram illustrating steps taken by a contact transitioning module of a contact support agent in accordance with an example embodiment of the present disclosure.

FIG. 3 is an example of a report generated by the contact transitioning module to support contact transitioning, according to an example embodiment.

FIG. 4 is an example of a further report information generated by the contact transitioning module to support contact transitioning, according to an example embodiment.

FIG. 5 is a simplified block diagram illustrating an example computer system for implementing one or more of the systems, modules and components shown in the environment of FIG. 1.

### DESCRIPTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments may be directed to other solutions.

Example embodiments are directed to systems and methods for improving identification and planning for potential lost/degraded contacts from the departure of an employee. Some example embodiments may enable contacts to be identified and transitioned in a resource efficient manner. For example, automated identification of contacts and alternative relationships may in some applications reduce the amount of interaction required between a human operator and electronic systems, thereby reducing the amount of processing time, human/machine interface wear, and power consumption that may otherwise be required gather the same amount of information. In some examples, data may be acquired that may not be available at all in the absence of the described embodiments. In example embodiments, a Relationship Database is accessed to identify all of the contacts that the departing employee has, how strong those relationships are, how much of the overall company-to-company relationship is made up of the departing employee's relationship, and to identify who, if anyone, has the next strongest relationship.

Example embodiments may allow an enterprise to identify if a contact is in jeopardy of being orphaned by the departure and allow the enterprise to react by, for example but not limited to, having the departing employee schedule an introduction with the contact for another employee (e.g., substitute employee) of the enterprise before they depart. This transitional hand-off will help the substitute employee start building a relationship with the contact and ensure that the contact is not orphaned. Under at least some privacy regulations, such a hand-off will be regulation complaint and not be considered a ‘cold-call’, thus allowing the employee being introduced to have a formal relationship to follow-up with after the initial employee departs.

Example embodiments may also enable the enterprise to identify all of the relationships where a departing employee is responsible for more than a pre-determined percentage of an overall value of a total relationship with a contact. This information will allow the enterprise to notify existing employees with the next strongest relationship with the contacts that they will need to increase their relationship strength to help cover the departing employee to avoid relationship decay.

Example embodiments may provide the enterprise with the information of all the contacts that the departing employee has in order to transition these to a potential substitute employee that will be filing the role of the departing employee.

For example, in the scenario where a Lead Salesperson puts their notice in with the enterprise, the enterprise can immediately have the departing salesperson setup meetings with contacts that the departing salesperson has the primary or sole relationship with. In addition to being aware of existing clients/customers being served by the salesperson, example embodiments would also allow the enterprise to capture any strong relationships that have not yet converted to a sale and have another salesperson be introduced prior to the Lead Salesperson's departure.

In another example scenario, a Senior Lawyer in a Law Firm is retiring. Example embodiments would allow the Law Firm to identify any contact relationships where the departing Lawyer has the strongest relationship, as well as the relationship strengths of others lawyers within the Law Firm with the same contacts. This information can be used to start moving the open files for that clients of the departing lawyer to the lawyer(s) with the next strongest relationship or to assign new lawyers to clients to start building new relationships.

The foregoing examples of the method are intended to be illustrative and not exclusive. Other methods will become apparent to those of skill in the art upon a reading of the specification and a study of the drawing.

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

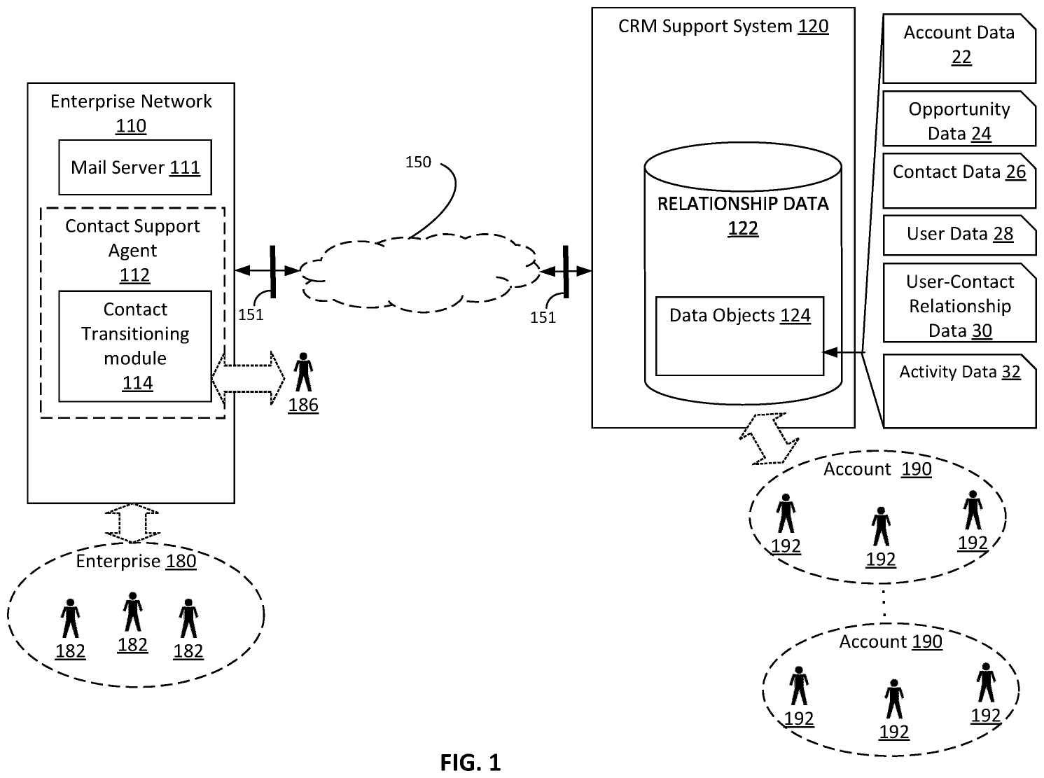

FIG. 1 is a simplified block diagram illustrating an environment that includes an enterprise network 110 and a CRM support system 120 in accordance with an example embodiment of the present disclosure. Each of enterprise network 110 and CRM support system 120 may, for example, include a plurality of computer devices, servers and systems that are linked to each other through one or more internal or external communication networks.

Enterprise network 110 supports an enterprise 180 such as a company, firm or other type of organization (referred to in this disclosure as “enterprise 180”). In example embodiments, a plurality of individuals are registered or otherwise associated with the enterprise network 110 as users 182 of the enterprise 180. These individual users 182 may for example be employees, owners, partners, consultants, volunteers, and interns of the enterprise 180.

At any given time the enterprise 180 has, or is, pursuing commercial relationships with one or more external entities, referred to in this disclosure as “accounts” 190. For example, such external entities could be existing or potential customers, clients or donors or other entities of interest to the enterprise, and may include, among other things, companies, partnerships, universities, firms, government entities, joint venture groups, non-government organizations, charities and other types of groups. In some examples, a large customer organization may have multiple divisions or groups that each are treated as a respective account 190 by enterprise 180. Typically, each account 190 will have an associated set of individual contacts, referred to in this disclosure as “contacts” 192. For example, the individual contacts 192 associated with an account 190 may be employees, owners, partners, consultants, volunteers, and interns of the account 190.

In the illustrated embodiment the CRM support system 120 is configured to track customer data on behalf of enterprise 180.

In the illustrated example, enterprise network 110, contact support agent 112, and CRM support system 120 are each connected to a common communication network 150. Communication network 150 may for example include the Intranet, one or more enterprise intranets, wireless wide area networks, wireless local area networks, wired networks and/or other digital data exchange networks. Respective firewalls 151 may be located between the communication network 150 and each of the enterprise network 110, contact support agent 112, and CRM support system 120. In different example embodiments, one or more of the features or functions of CRM support system 120 that are described herein could alternatively be implemented within the enterprise network 110.

In example embodiments, CRM support system 120 is configured to provide enhanced CRM information and functionality for enterprise 180. CRM support system 120 includes a relationship database 122 for storing relationship data generated in respect of the accounts 190 of interest to enterprise 180. In example embodiments, relationship database 122 may store, in respect of each account 190, data objects 124 that include: (I) account data 22 that provides general information about the account 190, (II) opportunity data 24 about specific opportunities that the enterprise has undertaken in the past, is currently undertaking, or is proposing to undertake in the future with the account 190, (III) individual contact data 26 that includes contact information for individual contacts 192 (e.g., employees) who are associated with the account 190, (IV) user data 28, that includes information about enterprise users 182 who are involved in the relationship with an account 190, (V) user-contact relationship data 30, and (VI) activity data 32 that includes information about activities between enterprise 180 and account 190.

In example embodiments, the CRM Support System 120 is configured to communicate with contact support agent 112 of enterprise network 110 in order to update and maintain the contents of relationship database 122. In some examples, CRM support system 120 is configured to periodically refresh (e.g., for example on a timed cycle such as once every 24 hours) the content of data objects 124 such that the data maintained in relationship database 122 always includes current or near-current information.

In example embodiments, the basic data included in account data 22 stored at relationship database 122 may include, for each respective account 190, some or all of the fields listed in the following Table 1, among other things:

TABLE 1
Account Data Fields:

| Field | Field Description |
|---|---|
| Enterprise ID | Unique identifier assigned to Enterprise |
| | 180 |
| Account ID | Unique identifier assigned to Account |
| | 190 |
| Account Industry Code | Code that identifies primary industry |
| | type of customer organization (e.g., |
| | Standard Industrial Classification (SIC) |
| | Code and/or North American Industry |
| | Classification System (NAICS) Codes) |
| Number of Employees | Number of Employees of Account |
| | Organization |
| Account Size Score | Score assigned based on size of |
| | account organization (e.g., organization |
| | size of 1500 += 10 points; 1000 to |
| | 1500 = 9 points; 750-1000 = 8 points, |
| | etc.). |
| Account Annual Revenue | Annual Revenue of account |
| | organization for one or more previous |
| | years |
| Owner User ID | User ID of enterprise user 182 who |
| | owns the account (e.g., user 182 who |
| | has primary responsibility for |
| | enterprise-account relationship) |
| Name | Name of Account (e.g., company |
| | name) |
| Top User-Account Relationship | The enterprise user 182 that has the |
| | strongest relationship with the account |
| | 190 |
| Account Active Indicator | Indicates that Account is currently |
| | active |

In example embodiments, the basic data included in opportunity data 24 stored at relationship database 122 may include, for each opportunity with each account 190, opportunity records that include some or all of the fields listed in the following Table:

TABLE 2
Opportunity Data Fields:

| Field | Field Description |
|---|---|
| Opportunity ID | Unique identifier assigned to |
| | Opportunity |
| Account ID | Account ID of the account that is the |
| | target of the opportunity |
| Created Date | Date opportunity registered with CRM |
| | support system |
| Closed Indicator | Indicates if opportunity is closed |
| Closed Date | Date Opportunity was closed |
| Won Indicator | Indicates opportunity closed |
| | successfully (e.g., with a sale) |
| Main Contact ID | Contact ID of lead contact for |
| | opportunity with the account |
| Main User ID | Contact ID of lead user for opportunity |
| Last Activity Date | Date of most recent activity recorded in |
| | respect of opportunity |

In example embodiments, the basic data included in contact data 26 stored at relationship database 122 may include, for each contact 192 at each account 190, contact records that include some or all of the fields listed in the following Table 3, among other things:

TABLE 3
Contact Data Fields:

| Field | Field Description |
|---|---|
| Contact ID | Unique contact identifier |
| Date Created | Date contact added |
| Account ID | Account ID of the account the contact is |
| | associated with |
| Department | Name of contact's department in the |
| | account organization |
| Title | Title/position of contact within account |
| | organization |
| Title Score | Score assigned to Contact based on |
| | contact's position at the account |
| | organization |
| Contact -Enterprise | Score That Indicates Perceived Value of |
| Relationship Score | the Relationship With Contact |
| First Name | Contact's First Name |
| Last Name | Contact's Last Name |
| Full Name | Contact's Full Name |
| Primary Email | Contact's Primary Email |
| Primary Phone | Contact's Primary Phone |
| Top User Relationship | Indicates the User that contact has the |
| | highest User-Contact Relationship Score with |

In example embodiments, the basic data included in user data 28 stored at relationship database 122 may include, for each user 182 that has a relationship with a contact 192 at an account 190, user records for that account that include some or all of the variable fields listed in the following Table 4, among other things:.

TABLE 4
User Data Fields:

| Field | Field Description |
|---|---|
| User ID | Unique user identifier |
| Account ID | Account ID of the subject account |
| Department | Name of user's department in the |
| | enterprise organization |
| Title | Title/position of user within enterprise |
| | organization |
| User-Account | Score That Indicates Perceived Value of |
| Relationship Score | User's Relationship With Contact |
| Opportunity ID (*) | Opportunity ID for opportunity for |
| | which user is member of the enterprise |
| | team (e.g., selling team) |

(*) Indicates fields that will be repeated as required

In example embodiments, the basic data included in user-contact relationship data 30 stored at relationship database 122 may include, for each user-contact relationship that exists between a user 182 within enterprise 180 and a contact 192 within the account 190, user-contact relationship records that include some or all of the variable fields listed in the following Table 5, among other things:

TABLE 5
User-Contact Relationship Data Fields:

| Field | Field Description |
|---|---|
| User ID | Unique user identifier |
| Contact ID | Contact Unique Identifier |
| Start Date | Date when relationship between user |
| | and contact started |
| Active Indicator | Indicates if relationship is currently |
| | active |
| User-Contact | Score that indicates perceived strength |
| Relationship Score | of User-Contact Relationship |
| Last Activity Date | Date of last recorded activity including |
| | user and contact |

In example embodiments, the activity data 32 stored at relationship database 122 may include data for activities related to the entity-account relationship. Activities may for example include communication activities and documentation activities among other things. Activity data 32 may include respective activity records for each logged activity. Each activity record may include, depending on the type of activity and availability of information, the variable fields listed in the following Table 6, among other things:

TABLE 6
Activity Data Fields:

| Field | Field Description |
|---|---|
| Activity ID | Unique identifier assigned to activity |
| Account ID | Identity of Account whose contacts |
| | participated in the activity |
| Opportunity ID | Identity of the opportunity that activity |
| | related to |
| Activity Type Indicator | Value that identifies the type of activity |
| | (e.g., (i) communication activity: |
| | incoming email, outgoing email, |
| | incoming meeting request, outgoing |
| | meeting request, incoming phone call, |
| | outgoing phone call, in-person meeting, |
| | virtual meeting, (ii) documentation |
| | activity: proposal submitted, draft |
| | statement of work (SOW) submitted; |
| | final SOW submitted; contract |
| | submitted for review). |
| Start Time | Date and time stamp indicating start of |
| | activity |
| Activity Duration | Duration of activity (e.g., length of |
| | meeting or phone call) |
| Participants - Account* | Contact IDs or other available identifier |
| | for all parties involved on account side |
| | of activity |
| Participants - Enterprise* | User IDs or other available identifier for |
| | all parties involved on enterprise side of |
| | activity |

*Indicates fields that will be repeated as required

In example embodiments, activity records can be created for future activities as well as activities that have already occurred. For example, data may be extracted from calendar data and or meeting invites to create activity records for planned events that have not yet occurred. The activity records can then be updated once the planned commuincation activity occurs.

In example embodiments, the CRM support system 120 is configured to log and record changes that occur in one or more of the variable fields so that changes in data can be tracked over time. In example embodiments, at some of the activity records such as activity records generated in respect of communication activities, included in activity data 32, are generated and at least partially populated based on information generated through automated tracking of electronic events that occur at enterprise network 110. Some activity records, such as activity records generated in respect of document events, may in at least some example be generated in response to information provided by a user 182 through an interface supported by contact support agent 112, which is then relayed to CRM support system through communication network 150.

Regarding activity data 32, in example embodiments, contact support agent 112 is configured to automatically collect information about communication activities between users 182 associated with the enterprise 180 and external contacts 192 associated with an account 190. These communication activities may for example be electronic communications such as email, meetings that are tracked in calendar systems and/or scheduled through email communications, and telephone calls that occur through a system that enables call logging. Each of these interactions have associated electronic data that includes a contact identifier (e.g., email address or phone number for contact 192), time stamp information for the interaction, and a user identifier (e.g., data that identifies the member(s) 182 of the enterprise 180 that were involved in the interaction.

In example embodiments, contact support agent 112 is configured to collect the information about communication activities by interacting with devices and systems that are integrated with enterprise network 110 and generate reports that are sent to CRM support system 120 automatically on a scheduled basis or when a predetermined threshold is met or a predetermined activity occurs. In some examples, contact support agent 112 may collect information from an enterprise mail server 111 located within enterprise network 110, and/or from calendar applications associated with enterprise network and users 182.

It will be noted that a number of the data objects include relationship scoring information, including: Account Data 22 includes a “Top User-Account Relationship” that identifies the enterprise user 182 that has the strongest relationship with the subject account 190; Contact Data 26 includes a “Contact-Enterprise Relationship Score” that that indicates a total perceived value of the enterprise's 180 relationship with the subject contact 192; User Data 28 includes a “User-Account Relationship Score” that indicates perceived value of user's relationship with contact; and User-Contact Relationship Data includes a “User-Contact Relationship Score” that indicates perceived strength of the user-contact relationship. According to example embodiments, the CRM support system 120 is configured with a set of relationship strength prediction models for computing each of the respective relationship scores. In at least some examples, these scores are calculated by CRM support system 120 based on communication activities between enterprise users 182 and account contacts 192, such as the communications activities that are tracked as part of activity data 32. By way of example, the User-Contact Relationship Score for an enterprise user 182 and account contact 192 could be based on features such as, among other things: activity type (e.g., incoming email, outgoing email, incoming meeting request, outgoing meeting request, incoming phone call, outgoing phone call, in-person meeting, on-line meeting, video conference); frequency (e.g., number of communication activities with a defined time period); recentness of communication activities; and length of communication activity, among other things. For example, a User-Contact Relationship Score could be quantified as a percentage (e.g., 0 to 100%) by applying a predetermined function, which may in some example be a deterministic linear rules-based model, and in other examples may be a trained non-linear predictive model. In example embodiments, a deterministic model may be derived by a data scientist based analysis of simulated data and real data using one or more statistical analysis methods.

By way of non-limiting example, a communication value based on frequency of communication, recentness of commuincation, and type of communication could be as follows:

Raw score=(total number incoming emails in last week from contact listing user as direct or CC recipient)*(W1)+(total number outgoing emails in last week from user listing contact as direct or CC recipient)*(W2)+(total number of phone calls, in-person meetings, and virtual meetings involving both user and contact in last week)*(W3)+(total number incoming emails in last month from contact listing user as direct or CC recipient)*(W4)+(total number outgoing emails in last month from user listing contact as direct or CC recipient)*(W5)+(total number of phone calls, in-person meetings, and virtual meetings involving both user and contact in last month)*(W6)+(total number incoming emails in last 6 moths from contact listing user as direct or CC recipient)*(W7)+(total number outgoing emails in last six months from user listing contact as direct or CC recipient)*(W8)+(total number of phone calls, in-person meetings, and virtual meetings involving both user and contact in last week)*(W9)+(total number of all communications activities involving both user and contact over lifetime of user-contact relationship)*(W10)

Where: W1 to W2 are predetermined weights. (e.g., W1=W2=7; W3=8, W4=W5=5, W6=6; W7=W8=3; W9=4; W10=1.

In example embodiments the raw score may be normalized to a communication value based on comparison with historical data and/or data for other user-contact relationships to a range or other scaling methodology to a range (for example 0 to 1). In some examples, the normalization may be based on data limited to the enterprise. In some examples, the normalization may be based on data from an industry. In some examples, normalization may be related to a specific account. In some examples, a communication momentum value may be based on trends over time in the metrics represented in the raw score calculation noted above.

In some example embodiments, User-Contact Relationship Score could be represented as a discrete ranking within a relative scale such as “3=high”, “2=medium”, “1=low”.

In some examples a User-Contact Relationship Score could be a composite of the contacts title score and a communication value based on the above attributes (e.g., contact title score*communication value). In some examples the User-Contact Relationship Score may be decided based only on the communication value. In some examples, “Contact-Enterprise Relationship Score” could be based on a combination (e.g., sum or product) of all of the individual User-Contact Relationship Scores that a contact 192 has with users 182 of enterprise 180. In some examples, a “User-Account Relationship Score” could be based on a combination (e.g., sum or product) of all of the individual User-Contact Relationship Scores that a user 182 has with account contacts 192; In some examples, the “Contact-Enterprise Relationship Score” could be based on a combination of all the individual User-Contact Relationship Scores across all user-contact relationships between an enterprise 180 and an account 190.

The term “employee” is used interchangeably with “user” throughout the remainder of the description to refer to a user 182 that is associated with enterprise 190. Referring to FIG. 1, when a departing employee is identified, the contact transitioning module 114 within the contact support agent 112 retrieves the contact information from the relationship database 122 to identify all of the contacts that the departing employee has a relationship with.

Examples of some possible relationship scoring methodologies are described in U.S. Pat. No. 9,633,057, issued Apr. 25, 2017, the content of which is incorporated herein by reference.

In the example embodiment, the contact transitioning module 114 reviews the contacts and the relationships between enterprise employees 182 and account contacts 192. The contact transitioning module 114 will review each contact that the departing employee has, and identify those contacts that do not have another established relationship with an enterprise employee 182.

In another embodiment, the contact transitioning module 114 will review each contact that the departing employee has, identify those contacts that do have another established relationship with an enterprise employee 182 and provide a summarization of the data to data steward 186 detailing the account contacts 192 of the departing employee such as, but not limited to, strength of relationship with those contacts, amount to which the departing employee constitutes the overall relationship with the contact, and which other enterprise employees 182 have an existing relationship with the account contact 192.

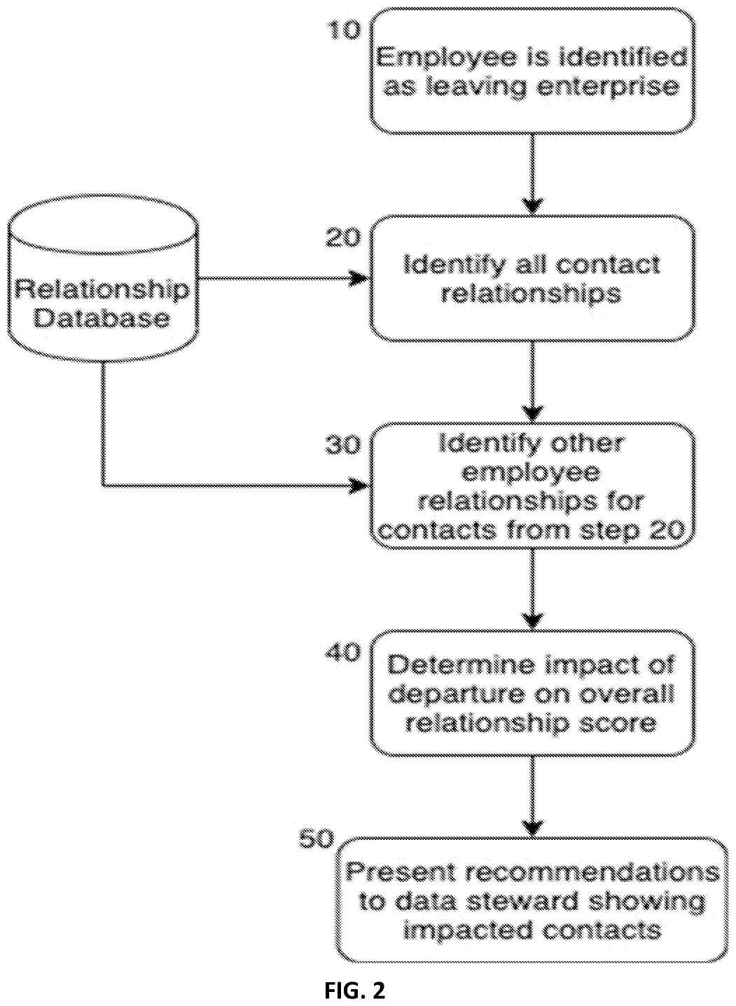

FIG. 2 is a flow diagram illustrating steps taken by a contact transitioning module 114 of a contact support agent 112 in accordance with an example embodiment of the present disclosure.

Step 10—In an example embodiment, the process of FIG. 2 is triggered when the contact transitioning module 114 receives a request to perform the process. For example, a data steward 186 or other authorized individual could enter a request for a transition plan for a specific employee through a computer system user interface. Such a request could for example be made when an enterprise employee provides notice that they are leaving the company, are retiring, or when an involuntary departure is identified. In some examples, a request could be made with no specific planned departure date for a particular individual, but rather for forecasting purposes, for example, when succession planning is being addressed and the enterprise 180 wants to ensure that they can adequately backfill a role/position.

Step 20—In an example embodiment, contact transitioning module 114 retrieves data for the departing enterprise employee 182 from the relationship database 122. For example, contact transitioning module may send a request through communication network 150 to CRM support system 120 for all relationship data available for the departing employee (e.g., specified user 182). Among other things, such relationship data identifies the employee's 182 existing relationships with contacts 192 with various accounts 190. The data retrieved for the employee 182 will include information pertaining to that employee in the data objects: account data 22 (e.g.: as per Table 1, identifies accounts for which the employee 182 is owner/has primary responsibility (Owner User ID), and has the strongest relationship with the account (Top User-Account Relationship)), opportunity data 24 (e.g., as per Table 2, identifies opportunities where employee 182 is the lead for the opportunity (Main User), contact data 26 (e.g., as per Table 3, identifies contacts that the employee has the Top User Relationship with), user data 28 (e.g., as per Table 4, identifies accounts where the employee has contact relationships, and the User-Account Relationship Score User-Contact), user-contact relationship data 30 (e.g., as per Table 5 identifies contacts that the departing employee has an existing relationship with and the individual user-contact relationship scores for each of those relationships), and activity data 32) (e.g., as per Table 6, identifies past and future planned activities of the employee with accounts and contacts).

Step 30—Contact transitioning module 114 retrieves from the relationship database 122 a list of any other enterprise employees 182 that the account contacts 192 identified in Step 20 have an established relationship with. The contact transitioning module 114 may, for example, retrieve relationship data from user-contact relationship data 30 and activity data 32 from the relationship database 122 for these other employee-contact relationships.

Step 40—In the example embodiment, the contact transitioning module 114 evaluates the relationship data from step 20 and step 30 and determines information such as, but not limited to: (i) a list of all account contacts 192 that the departing enterprise employee 182 has, (ii) the strength of relationship with those account contacts 192, (iii) the amount to which the departing enterprise employee 182 constitutes the overall relationship with the identified accounts contact 192, (iv) which enterprise employee 182 has the next strongest relationship score, and (v) which account contacts 192 do not have a relationship with any other enterprise employee 182.

Step 50—In example embodiments, the contact transitioning module 114 will present the available information to a data steward 186 (who may be an authorized user enterprise 180, for example, or may be a further automated system in some examples). Such information may include information, such as but not limited to, detailing account contacts 192 that will be impacted by the departure of the enterprise employee, all account contacts 192 where the departing employee comprises more than a configurable percentage of the entire enterprise's relationship to that account contact 192, and which other enterprise employees 182 have a relationship with each impacted account contact 192.

In example embodiments the determination as to whether the departing employee comprises more than a configurable percentage of the entire enterprise's relationship to a specific contact can be determined by dividing the User-Contact Relationship Score by the Contact-Enterprise Relationship Score, multiplying the result by 100 and determining if the percentage is above or below a predefined threshold value. Similarly, the contact transitioning module 114 may also be configured to determine the accounts for which the departing employee comprises more than a configurable percentage of the entire enterprise's relationship to a specific account can be determined by dividing the User-Account Relationship Score by the Enterprise-Account Relationship Score, multiplying the result by 100 and determining if the percentage is above or below a further predefined threshold value.

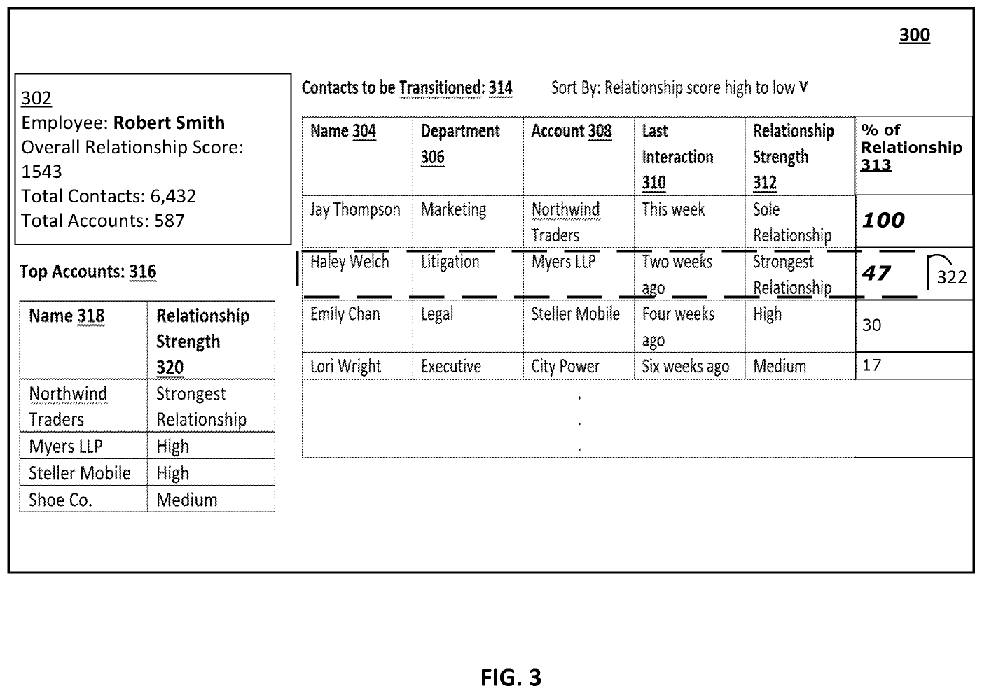

By way of example, FIG. 3 illustrates a report 300 that may be generated by contact transitioning module 114 for a data steward 186. Although report 300 can be generated in different formats (e.g., through a user interface display, printed, and/or as machine readable electronic data format), in at least some examples report 300 is presented in an interactive user interface display for the data steward 186, using a display device.

In the example of FIG. 3, report 300 includes a first region 302 that includes information about the departing employee, including for example name, overall relationship score (e.g., a sum of all the user-contact relationship scores for all known relationships of the departing employee), total individual contacts of the departing employee, and the total number of accounts that have contacts who have a relationship with the departing employee.

Report 300 also include a list 316 of “Top Accounts”, which lists the accounts that the departing employees has the highest User-Account Relationship Scores with. The Top Accounts list 316 could be configured to include up to a defined number of accounts (e.g., as listed in “Name” column 318), ranked by User-Account Relationship Scores (e.g., relationship strength 320).

Report 300 can also include a list 314 of contacts of the departing employee that need to be transitioned. List 314 may for example include columns that identify, for each of the departing employee's contacts: name 304, department 306, account 308, timing of last interaction between contact and departing employee 310, relationship strength between contact and departing employee 312 (e.g., User-Contact Relationship Score), and percentage of relationship 313 (e.g., User-Contact Relationship Score divided by Contact-Enterprise Relationship Score*100). In some examples, as indicated by the bolded, italicized, values in the percentage of relationship 313 column, a contact may be flagged in report 300 if the percentage of relationship value exceeds a threshold (for example, 40%).

In some examples where the report 300 is presented in an interactive user interface, the order in which contacts are presented may be user configurable, for example “Sort by: relationship score high to low”; or “Sort by: Last Interaction, newest to oldest”. In example embodiments, the contact transition module 114 is configured to enable data steward 182 to use an on-screen navigation and selection tool 322 to request further information in respect of a specific contact 192.

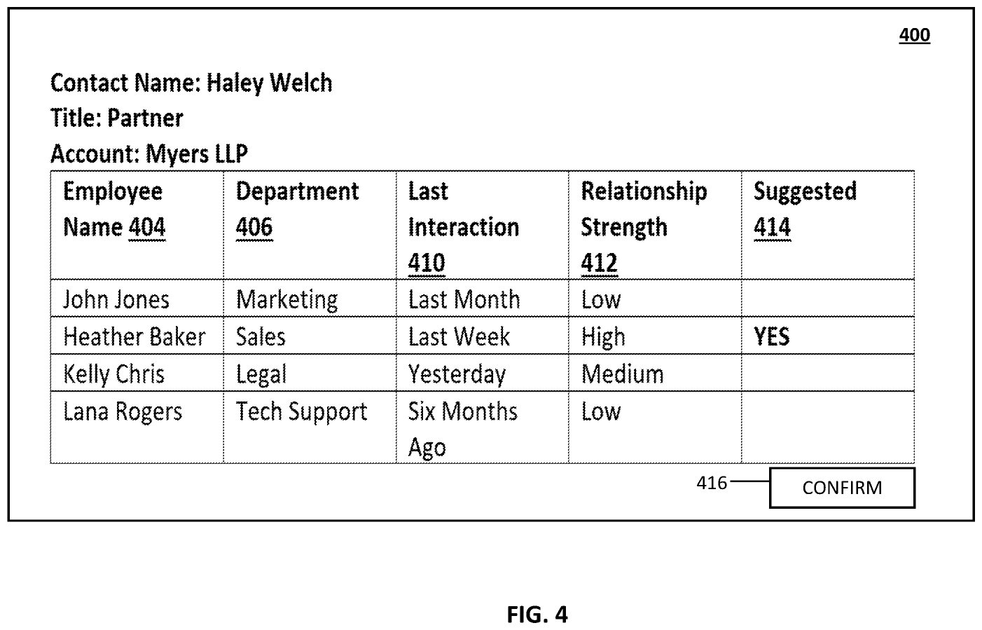

FIG. 4 displays further information 400 in the report generated by contact transition module 114 in respect of a departing employee. In particular, information 400 is generated in respect of a specific contact 192, e.g. “Haley Welch”, of the departing employee. In some examples, the information 400 is displayed in a user interface on a display screen in response to an input by the data steward selecting the specific contact from report 300. Contact specific information 400 includes a list of possible substitute employees (e.g. users 182) of enterprise 180 that also have an existing relationship, as identified in relationship database 122. As indicated in FIG. 4, the list of other employees can include columns that identify, for each of the possible substitute employees: name 404, department 406, timing of last interaction with contact 410, and relationship strength between contact and listed employee 312 (e.g., User-Contact Relationship Score).

In example embodiments, contact transition module 114 is configured to apply a predetermined policy or set of rules to automatically identify which of the listed employees is most appropriate to take some form of transition action with respect to the contact. The policy could for example be based on selecting the employee in a defined set of departments who has the highest User-Contact Relationship Score. For example, in FIG. 4, employee “Heather Baker” is listed as a suggested (Column 414) employee for a transition action. The transition action may include one or more activities, including: suggesting that the identified employee “Heather Baker” be included in a transition communication such as a meeting or email; and/or suggesting that the identified employee “Heather Baker” take over as a lead or owner for the contact and/or account/and or/opportunity. Suggested timelines can also be provided for the transition actions. In some examples, the identified employee and suggested transition action(s) and timing are automatically generated by contact transition module 114 based on predefined policies and rules, and are communicated to designated users 182 through electronic messaging such as email. In some examples, the suggestions are automatically communicated once a data steward has indicated, by way of predefined user input (e.g., selection of a “confirm” option 416 using a navigation and selection tool) , that they accept the suggested substitute employee and transitions actions. The designated users could for example include one or more of the data steward 400, the departing employee, the identified substitute employee, and/or others. In some examples, a plurality of substitute employees may be suggested.

In some examples, suggested actions may be based on future activities that are identified in activity data 32. For example, activity data 32 may indicate that the departing employee has a meeting scheduled in the next week with a contact 192. Contact transitioning module 114 can be configured to indicate as a suggested action that the substitute employee be sent an invite to attend the meeting. In some example's, contact transitioning module 114 may be configured to automatically send the meeting invite to the substitute employee once the substitute employee has been approved.

In at least some example embodiments, once the substitute employee is included in a communication activity with the contact that activity will be automatically detected in the manner described above and recorded in the relationship database 122, thereby increasing the relationship score of that substitute employee with the contact.

In at least some examples, after approval by data steward, contact transitioning module 114 is configured to, as one of the transition actions, automatically communicate information about the departing employee and the substitute employee to CRM support system 120 to replace the departing employee with the substitute employee as “lead user” in respect of Accounts and Opportunities where the departing employee was previously identified in that role.

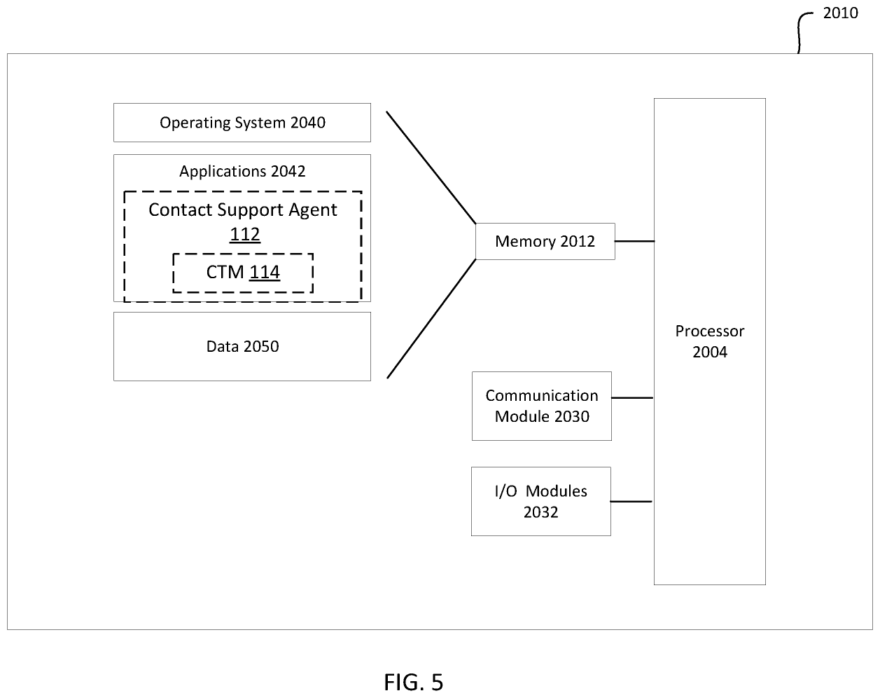

Referring to FIG. 5, an example embodiment of a computer system 2010 for implementing one or more of the modules, systems and agents included in enterprise network 110 and CRM support system 120 will be described. In example embodiments, computer system 2010 may be a computer server. The system 2010 comprises at least one processor 2004 which controls the overall operation of the system 2010. The processor 2004 is coupled to a plurality of components via a communication bus (not shown) which provides a communication path between the components and the processor 2004. The system comprises memories 2012 that can include Random Access Memory (RAM), Read Only Memory (ROM), a persistent (non-volatile) memory which may one or more of a magnetic hard drive, flash erasable programmable read only memory (EPROM) (“flash memory”) or other suitable form of memory. The system 2010 includes a communication module 2030, and one or more I/O modules 2032 such as a user display screen and a user input device.

The communication module 2030 may comprise any combination of a long-range wireless communication module, a short-range wireless communication module, or a wired communication module (e.g., Ethernet or the like) to facilitate communication through communication network 150.

Operating system software 2040 executed by the processor 2004 may be stored in the persistent memory of memories 2012. A number of applications 2042 executed by the processor 2004 are also stored in the persistent memory. The applications 2042 can include software instructions for implementing the systems, methods, agents and modules described above. For example applications 2042 may include software instructions required for implementing contact support agent 112 and contact transitioning module 114. In some examples, the same computer system 2012, or a different computer system 2012, can also include the software instructions required for implementing CRM support systems 120. In some examples, the functionality of contact support agent 112 and contact transitioning module 114 could be distributed across multiple computer systems 2012. Similarly, in some examples, the functionality of CRM support system 120 could be distributed across multiple computer systems 2012.

The system 2010 is configured to store data that may include data objects 124 and customer data, in the case of CRM support system 120.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer implemented method for aiding maintenance of a relationship database, comprising:
receiving information identifying a departing user;
retrieving, from the relationship database, relationship data for a plurality of individual contacts identified in the relationship database as having an existing relationship with the departing user;
retrieving, from the relationship database, relationship data for other users identified in the relationship database as having existing relationships with the individual contacts; and
generating a report identifying the individual contacts and the other users that have existing relationships with the individual contacts, the report including relationship information based on the retrieved relationship data about the existing relationship of the departing user with the individual contacts and the existing relationships of the other users with the individual contacts.

2. The computer implemented method of claim 1 wherein the retrieved relationship data includes a user-contact relationship score for each of the existing relationships, the user-contact relationship score indicating a perceived value of the existing relationship, and the relationship information included in the report includes the user-contact relationship scores.

3. The computer implemented method of claim 2 comprising automatically determining, based on the user-contact relationship scores, substitute users for transitioning at least some of the existing relationships of the departing user, and indicating the substitute users and respective individual contacts in the report.

4. The computer implemented method of claim 3 comprising automatically notifying one or more parties through electronic messaging of the substitute users.

5. The computer implemented method of claim 3 comprising automatically notifying the relationship database of the substitute users.

6. The computer implemented method of claim 3 wherein the retrieved relationship data identifies scheduled future activities between the departing user and the individual contacts, and the method comprises automatically advising the respective substitute users of the scheduled future activities.

7. The computer implemented method of claim 3 comprising presenting the report through a user interface to a data steward and receiving input through the user interface confirming the determined substitute users.

8. The computer implemented method of claim 2 wherein the retrieved relationship data includes an indication of a last interaction for each of the existing relationships, and the relationship information included in the report includes the indications of last interaction.

9. The computer implemented method of claim 2 wherein the retrieved relationship data includes, for each individual contact an overall individual relationship score that is based on a total of the user-contact relationship scores for the individual contact with the departing user and all other users identified as having an existing relationship with the individual contact, and the report includes an indication of a relationship of the user-contact relationship score for the individual contact with the departing user relative to the overall individual relationship score.

10. The computer implemented method of claim 2 wherein the user-contact relationship scores are based on historical communication activities the departing user and the other users have each had with the individual contacts, wherein the method comprises automatically tracking the historical communication activities by monitoring electronic communication activities involving the departing user and the other users and providing information about the electronic communication activities to the relationship database.

11. A computer system comprising a processor and persistent storage storing computer instructions that when executed by the processor configure the computer system to:
receive information identifying a departing user;
retrieve, from a relationship database, relationship data for a plurality of individual contacts identified in the relationship database as having an existing relationship with the departing user;
retrieve, from the relationship database, relationship data for other users identified in the relationship database as having existing relationships with the individual contacts; and
generate a report identifying the individual contacts and the other users that have existing relationships with the individual contacts, the report including relationship information based on the retrieved relationship data about the existing relationship of the departing user with the individual contacts and the existing relationships of the other users with the individual contacts.

12. The computer system of claim 11 wherein the retrieved relationship data includes a user-contact relationship score for each of the existing relationships, the user-contact relationship score indicating a perceived value of the existing relationship, and the relationship information included in the report includes the user-contact relationship scores.

13. The computer system claim 12, wherein the computer system is configured to determine, based on the user-contact relationship scores, substitute users for transitioning at least some of the existing relationships of the departing user, and indicating the substitute users and respective individual contacts in the report.

14. The computer system claim 13, wherein the computer system is configured to notify one or more parties through electronic messaging of the substitute users.

15. The computer system claim 13, wherein the computer system is configured to notify the relationship database of the substitute users.

16. The computer system of claim 3 wherein the retrieved relationship data identifies scheduled future activities between the departing user and the individual contacts, and the computer system is configured to advise the respective substitute users of the scheduled future activities.

17. The computer system claim 13, wherein the computer system is configured to present the report through a user interface to a data steward and receiving input through the user interface confirming the determined substitute users.

18. The computer system of claim 12 wherein the retrieved relationship data includes, for each individual contact an overall individual relationship score that is based on a total of the user-contact relationship scores for the individual contact with the departing user and all other users identified as having an existing relationship with the individual contact, and the report includes an indication of a relationship of the user-contact relationship score for the individual contact with the departing user relative to the overall individual relationship score.

19. The computer system of claim 12 wherein the user-contact relationship scores are based on historical communication activities the departing user and the other users have each had with the individual contacts, wherein the computer system is configured to automatically track the historical communication activities by monitoring electronic communication activities involving the departing user and the other users and providing information about the electronic communication activities to the relationship database.

20. A computer readable medium storing, in a persistent manner, computer software instructions that when executed by a processor configure the processor to:
receive information identifying a departing user;
retrieve, from a relationship database, relationship data for a plurality of individual contacts identified in the relationship database as having an existing relationship with the departing user;
retrieve, from the relationship database, relationship data for other users identified in the relationship database as having existing relationships with the individual contacts; and
generate a report identifying the individual contacts and the other users that have existing relationships with the individual contacts, the report including relationship information based on the retrieved relationship data about the existing relationship of the departing user with the individual contacts and the existing relationships of the other users with the individual contacts.
